(19) United States
(12) Patent Application Publication
(10) Pub. No.: US 2017/0285212 A1
(43) Pub. Date: Oct. 5, 2017

(54) SYSTEM AND METHOD FOR MEASURING DOWNHOLE PARAMETERS

(71) Applicant: Schlumberger Technology Corporation, Sugar Land, TX (US)

(72) Inventor: Richard Bloemenkamp, Clamart (FR)

(21) Appl. No.: 15/468,177

(22) Filed: Mar. 24, 2017

(30) Foreign Application Priority Data
Apr. 1, 2016 (EP) 16290060.9

(51) Int. Cl. G01V 3/20; E21B 49/00

(52) U.S. Cl. CPC G01V 3/20; E21B 49/00

(57) ABSTRACT

An apparatus and method for making resistivity measurements of an underground formation surrounding a borehole is disclosed. The apparatus includes a conductive tool body section. The apparatus includes an electrically decoupling insulated tool body section mechanically coupled to the conductive tool body section. The apparatus includes a conductive current return (CR) tool body section mechanically coupled to the electrically decoupling insulated tool body section. The apparatus includes a pad mounted on the conductive tool body section that injects current into the formation at a frequency in a range above 100 kHz and below 10 MHz. The pad includes at least one button electrode that measures current injected into the formation. The pad also includes a standoff spacer affixed to the conductive plate configured for direct contact with the formation. The apparatus includes extendable suspension means affixed to the conductive plate, that, when extended, cause direct contact between the standoff spacer and the formation.

### CROSS-REFERENCE TO RELATED APPLICATIONS

The present invention claims the benefits of European Patent Application No. 16290060.9, filed on Apr. 1, 2016, titled “System And Method For Measuring Downhole Parameters,” the entire content of which is hereby incorporated by reference into the current application.

### BACKGROUND

### Field of the Disclosure

The present invention relates to techniques for performing wellbore measurements. More particularly, the present invention relates to techniques for determining downhole characteristics, such as electrical parameters of downhole fluids and/or subterranean formations.

### Background

Oil rigs are positioned at well sites for performing a variety of oilfield operations, such as drilling a wellbore, performing downhole testing and producing located hydrocarbons. Downhole drilling tools are advanced into the earth from a surface rig to form a wellbore. Drilling muds are often pumped into the wellbore as the drilling tool advances into the earth. The drilling muds may be used, for example, to remove cuttings, to cool a drill bit at the end of the drilling tool and/or to provide a protective lining along a wall of the wellbore (or borehole). During or after drilling, casing is typically cemented into place to line at least a portion of the wellbore. Once the wellbore is formed, production tools may be positioned about the wellbore to draw fluids to the surface.

During drilling, measurements are often taken to determine downhole conditions. In some cases, the drilling tool may be removed so that a wireline testing tool may be lowered into the wellbore to take additional measurements and/or to sample downhole fluids. Once the drilling operation is complete, production equipment may be lowered into the wellbore to assist in drawing the hydrocarbons from a subsurface reservoir to the surface.

The downhole measurements taken by the drilling, testing, production and/or other well site tools may be used to determine downhole conditions and/or to assist in locating subsurface reservoirs containing valuable hydrocarbons. Such well site tools may be used to measure down-hole parameters, such as temperature, pressure, viscosity, resistivity, etc. Such measurements may be useful in directing the oilfield operations and/or for analyzing downhole conditions.

Various techniques have been developed for measuring downhole parameters as described, for example, in U.S. Pat. Nos. 6,801,039, 6,191,588, 6,919,724, 7,066,282, 6,891,377, 5,677,631, 5,574,371, 4,567,759, and 3,816,811. In some cases, techniques have been generated for determining parameters of the formations surrounding the borehole. For example, micro-resistivity measurements of borehole walls may be taken to generate images of formations surrounding the borehole. Such micro-resistivity measurements may be taken using downhole tools, such as a Full-bore Micro Imager (FMI™) of SCHLUMBERGER™.

In one example, measurements may be taken using current injection when the borehole is filled with a conductive fluid or mud. Where a non-conductive fluid is present, such as oil-based mud (OBM) with a very high resistivity compared to that of the formation such that a thin layer of mud between a measurement electrode and the formation, high impedance is generated between the electrode and the formation. Another example mounts one or more button voltage electrodes on an insulating pad, such as is used in the Oil Base Micro Imager tool (OBMI™) of SCHLUM-BERGER™.

Stability problems may sometimes occur in cases where a measurement electrode touches the formation, or if the mud has conductive bubbles in it which form a low-impedance electrical connection between the measurement electrode and the formation. High impedance between the electrode and the formation can suddenly reduce to very small impedance or vice versa, which may lead to a change in the measurement that is not due to a change in formation parameters. For example, a small change from 0.10 mm to 0.00 mm mud thickness can lead to a notable change in impedance. In general, both the magnitude and the phase of the impedance can change drastically.

### SUMMARY

In at least one aspect, the invention relates to an apparatus for making resistivity measurements of an underground formation surrounding a borehole. The apparatus can include a conductive tool body section. The apparatus can also include an electrically decoupling insulated tool body section mechanically coupled to the conductive tool body section. The apparatus can also include a conductive current return (CR) tool body section mechanically coupled to the electrically decoupling insulated tool body section. In an embodiment, the conductive CR tool body section that, when in use, comes into direct contact with the formation. The apparatus can also include a pad mounted on the conductive tool body section. The pad can include a conductive plate that injects current into the formation at a frequency in a range above 100 kHz and below 10 MHz. The pad can also include at least one button electrode that measures current injected into the formation. The pad can also include a standoff spacer affixed to the conductive plate. In an embodiment, the standoff spacer makes direct contact with the formation during use. The apparatus can also include extendable suspension means affixed to the conductive plate, that, when extended, cause direct contact between the standoff spacer and the formation.

In at least one aspect, the invention relates to a method for measuring downhole parameters of an underground formation, the underground formation having a wellbore extending therethrough. The method can include deploying the downhole tool into the wellbore. The down-hole tool used in the method can include the apparatus described above. The method can also include positioning the pad adjacent to the subterranean formation for electrically coupling to the formation without direct contact. The method can also include passing an electrical signal I having a frequency in a range above 100 kHz and below 10 MHz into the ormation. The method can also include measuring at least one downhole parameter of the formation from the electrical signal I at a location along the conductive CR tool body section electrically decoupled from the pad.

These together with other aspects, features, and advantages of the present disclosure, along with the various features of novelty, which characterize the invention, are pointed out with particularity in the claims annexed to and forming a part of this disclosure. The above aspects and advantages are neither exhaustive nor individually or jointly mandatory to the spirit or practice of the disclosure. Other aspects, features, and advantages of the present disclosure will become readily apparent to those skilled in the art from the following detailed description in combination with the accompanying drawing. Accordingly, the drawings and description are to be regarded as illustrative in nature, and not restrictive.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, certain components may be not labeled in some drawings.

FIGS. 1A and 1B are schematic views of a well site having a cased wellbore and a system for measuring downhole parameters therein. FIG. 1A depicts a drilling downhole tool.

FIG. 1B depicts a wireline downhole tool.

FIG. 2A is a schematic view of a portion of a downhole tool with a sensor pad thereon.

FIG. 2B is a cross-sectional view of the downhole tool of FIG. 2A taken along line 2B-2B.

FIG. 3A is a cross-sectional view of a portion of the downhole tool of FIGS. 2A and 2B, depicting a sensor pad. FIG. 3B is an exploded view of the portion of the downhole tool of FIG. 3A.

FIGS. 4A and 4B are cross-sectional views of a portion of a downhole tool similar to that of FIGS. 2A and 2B in accordance with another embodiment.

FIG. 5 depicts a conductive pad of the downhole tool of FIGS. 3A-3B, or FIGS. 4A-4B, in accordance with one embodiment.

### DETAILED DESCRIPTION

The description that follows includes examples of conductive pads, methods, techniques, and instruction sequences that embody techniques of the present inventive subject matter. However, it is understood that the described embodiments may be practiced without these specific details. Certain embodiments of the disclosure are shown in the above-identified Figures and described in detail below.

In the following description, by convention a “top” element refers to an element positioned closer to the surface than a “bottom” element in a vertical borehole, i.e., a “top” element is above a “bottom” element. However, those versed in the art would easily adapt this terminology to inclined borehole or horizontal borehole.

It may be desirable in some cases to provide a minimum distance or stand-off between a measurement pad and the borehole wall. Attempts have been made to provide protruding elements, for example protruding wear plates, on the sensor pad to touch the formation and keep the pad's front face away from the formation. However, existing protruding devices may be subject to damage in downhole conditions, may still have problems with measurements where conductive bubbles are present in the mud, and may be subject to large standoff variations during the logging process.

Mechanical pad suspension systems are more costly, are larger and more complex making them less interesting for certain applications. Larger systems also are problematic for tools used in small diameter boreholes and for certain tool conveyance systems employing tools that pass through small restrictive openings.

It is known that pads can be made smaller when electrical current is returned not to return electrodes on the pads but to a mandrel-based current return. One example of a mandrel current return configuration is described in U.S. Pat. No. 8,232,803, incorporated by reference in its entirety. However, mandrel-based current return configurations have not provided as high an image resolution and measurement quality as the pad-based current return systems. In order to produce useable images with a mandrel current-return system, the measurement current distribution is maintained stable and not fluctuating. Stability can be compromised due to potentially intermittent electrical contact between non-insulated parts of the pads and the formation or between parts of the tool that are in electrical contact with the pads and the formation.

The invention relates to techniques for measuring downhole parameters. A downhole tool with a conductive pad is configured to minimize a distance between the electrode and a wall of the wellbore, eliminate direct contact with the formation and/or highly conductive bubbles in the mud, and to protect components thereof. Current is injected at the conductive pad, and returned to a section of the tool mandrel that is electrically decoupled, or isolated, from the conductive pad, but in direct contact with the formation. This configuration may also be used to provide accuracy of measurement, optimized measurement processes, reduced clogging, minimized components, reduced size, increased surface area for measurement, constant flow of fluids during measurement, optimized shape of measurement pad/system, compatibility with existing well site equipment, operability in downhole conditions (e.g., at high temperatures and/or pressures), etc. The conductive pad injects current into the formation surrounding the borehole at a frequency above around 100 kHz up to around 10 MHz in one embodiment. In an embodiment, the operating frequency is selected as 1 MHz. The conductive pad includes a standoff spacer, which can include insulation as well as a wear plate, that maintains a standoff optimized for resolution and stable current distribution.

The present disclosure extends to benefit by increased operating frequency. At low frequencies, the impedance of the mud between the electrode and the formation dominates the current measurement such that its sensitivity to the formation resistivity is low. As the frequency increases, the mud impedance decreases because oil based mud acts like a (lossy) capacitor and the impedance across a capacitor decreases with frequency. However, for a large part of the interesting formation resistivity range, the formation is dominantly resistive and the impedance of the formation is less frequency dependent.

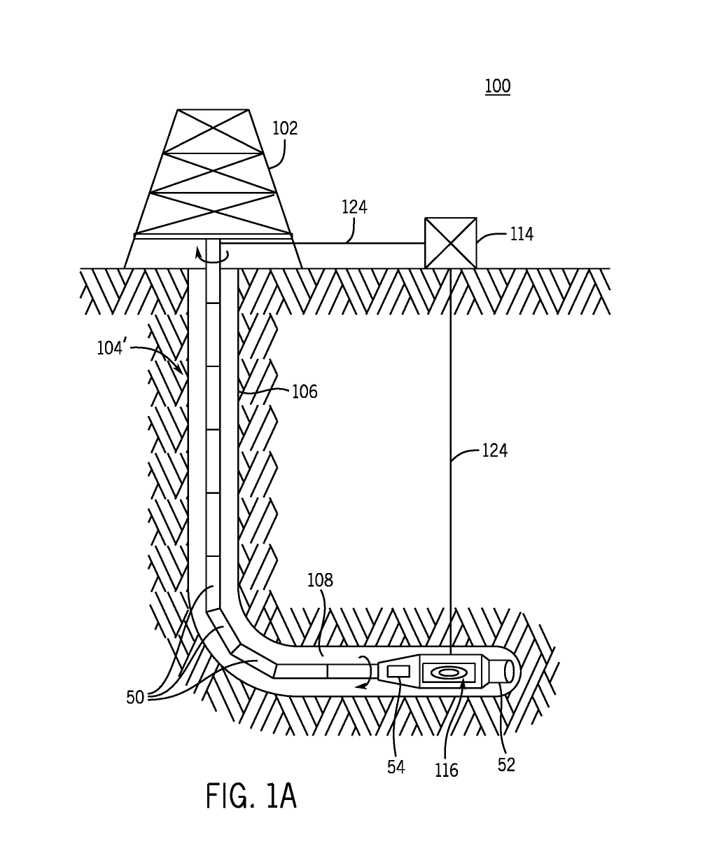

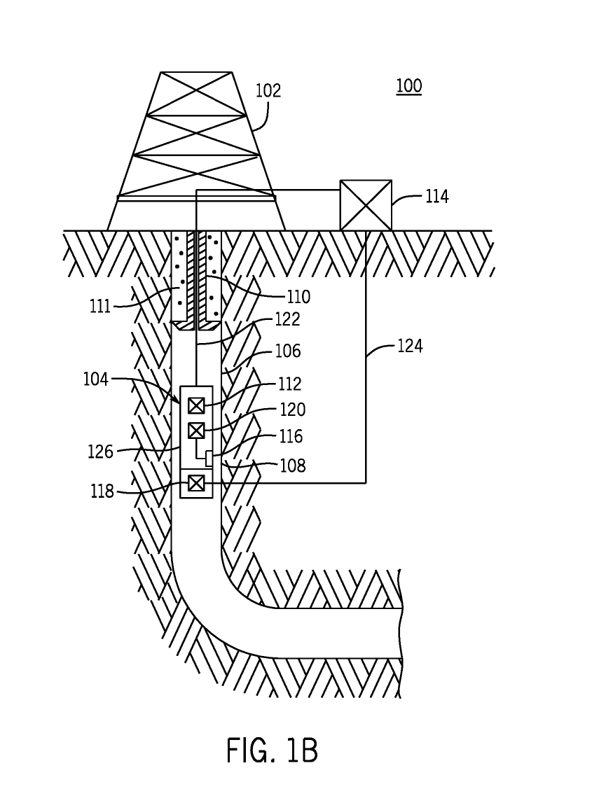

FIGS. 1A and 1B are schematic views of a well site 100 having an oil rig 102 with a downhole tools 104′ and 104, respectively, suspended into a borehole 106 therebelow. As shown in FIG. 1A, the downhole tool 104′ is a conventional drilling tool. The borehole 106 has been drilled by the drilling downhole tool. The drilling tool 104′ includes a plurality of drill pipe 50 with a drill bit 52 at an end thereof. The drilling tool also has a conventional logging while drilling (“LWD”) tool 54 which may be in communication with a surface unit 114 via communication link 124, and a conductive pad 116. A drilling mud, and/or a wellbore fluid 108, may have been pumped into the borehole 106 and may line a wall thereof. Once drilling is complete, the drilling tool 104′ may be removed, and a casing 110 may also be positioned in a portion of the borehole 106 and cemented into place therein by a cement 111 as shown in FIG. 1B.

As also shown in FIG. 1B, the downhole tool 104 is shown as a wireline logging tool lowered into the borehole 106 to take various measurements. The downhole tool 104 may be inserted into the well before or after placement of the casing 110 into the borehole 106. The down-hole tool 104 may include a conventional logging device 112, a conductive pad 116, one or more telemetry devices 118, and an electronics package 120.

The conventional logging device 112 may be provided with various sensors, measurement devices, communication devices, sampling devices and/or other devices for performing wellbore operations. The downhole tool 104 may include one or more sensors for determining one or more downhole parameters, such as wellbore fluid parameters, wellbore integrity parameters and/or formation parameters. For example, as the downhole tool 104 is lowered, the logging device 112 may use devices, such as resistivity or other logging devices, to measure downhole parameters and/or properties.

As shown, the downhole tool 104 may be conveyed into the borehole 106 on a wireline 122. Although the downhole tool 104 is shown as being conveyed into the borehole 106 on a wireline 122, it should be appreciated that any suitable conveyance may be used, such as a slick line, a coiled tubing, a drill string, a casing string, a logging tool and the like. The downhole tool 104 may be operatively connected to the surface unit 114 for communication therebetween. The downhole tool 104 may be wired via the wireline 122, as shown, and/or wirelessly linked via the one or more telemetry devices 118. The one or more telemetry devices 118 may include any telemetry devices, such as electromagnetic devices, for passing signals to a surface unit 114 as indicated by communication link 124. Further, it should be appreciated that any communication device or system may be used to communicate between the downhole tool 104 and the surface unit 114. Signals may be passed between the downhole tool 104 and the surface unit 114 and/or other locations for communication therebetween. Data may be passed to the surface by the communication link 124, and/or stored inside the downhole tool 104 for download upon retrieval to the surface.

While the downhole tool 104 is depicted as the wireline tool 104 having the conductive pad 116 thereon, it will be appreciated that the conductive pad 116 may be positioned downhole on a variety of one or more tools. For example, the conductive pad 116 may be placed downhole on a variety of downhole tools, such as a drilling, coiled tubing, drill stem tester, production, casing, pipe, completions, or other downhole tool. Although a single conductive pad 116 is shown, it should be appreciated that one or more conductive pads 116 and/or portions of the conductive pads 116 may be located at several locations in the borehole 106.

The conductive pad 116 is a current injection component located on the downhole tool 104 and positionable adjacent a wall of the wellbore for measurement thereof. The conductive pad 116 can be positioned about an outer surface of the downhole tool 104 so that the downhole fluid and/or the formation may pass therealong for measurement thereof. However, it will be appreciated that the one or more conductive pads 116 may be positioned at various locations about the well site 100 as desired for performing fluid measurement.

The electronics package 120 may include any components and/or devices suitable for operating, monitoring, powering, calculating, calibrating, and analyzing components of the downhole tool 104. Thus, the electronics package 120 may include, for example, a power source, a processor, a storage device, a signal conversion (digitizer, mixer, amplifier, etc.), a signal switching device (switch, multiplexer, etc.), a receiver device and/or a transmission device, and the like (not shown). The electronics package 120 may be operatively coupled to the conductive pad 116. The power source in the electronics package 120 may apply a voltage to the conductive pad 116. The power source may be provided by a battery power supply or other conventional means of providing power. In some cases, the power source may be an existing power source used in the downhole tool 104. The power source may be positioned, for example, in the downhole tool 104 and wired to the conductive pad 116 for providing power thereto as shown. Optionally, the power source may be provided for use with the conductive pad 116 and/or other downhole devices. Although the electronics package 120 is shown as one separate unit from the conductive pad 116, it should be appreciated that any portion of the electronics package 120 may be included within the conductive pad 116. Further, the components of the electronics package 120 may be located at various locations about the downhole tool 104, the surface unit 114 and/or the well site 100. The conductive pad 116 may also be wired or wirelessly connected to any of the features of the downhole tool 104, and/or surface unit 114, such as communication links 124, processors, power sources or other features thereof.

The conductive pad 116 can be used to inject a current measured in determining one or more downhole parameters, such as one or more downhole fluid parameters and/or one or more formation parameters. The downhole fluids may include any downhole fluids such as downhole mud 108 (e.g., oil and/or water based), hydrocarbons, water and/or other downhole fluids. The conductive pad 116 may be positioned on the downhole tool 104 in such a manner that the conductive pad 116 injects current for assessment fluids and/or downhole formations as the downhole tool 104 passes through the wellbore 106 under the harsh conditions of the downhole environment. Further, the conductive pad 116 may be positioned in such a manner that reduces clogging of downhole fluids as the downhole fluids pass the conductive pad 116.

As shown, the conductive pad 116 is positioned on an outer surface 126 of the downhole tool 104. The conductive pad 116 may have an insulating layer covering one or more electrodes in the conductive pad 116. The conductive pad 116 may be flush with the outer surface 126 of the downhole tool 104. Further, the conductive pad 116 may be recessed a distance below the outer surface 126 to provide additional protection thereto as well as to offset for reasons discussed herein, or protruded a distance therefrom to access fluid and/or formation. The conductive pad 116 may also be positioned at various angles and locations as desired.

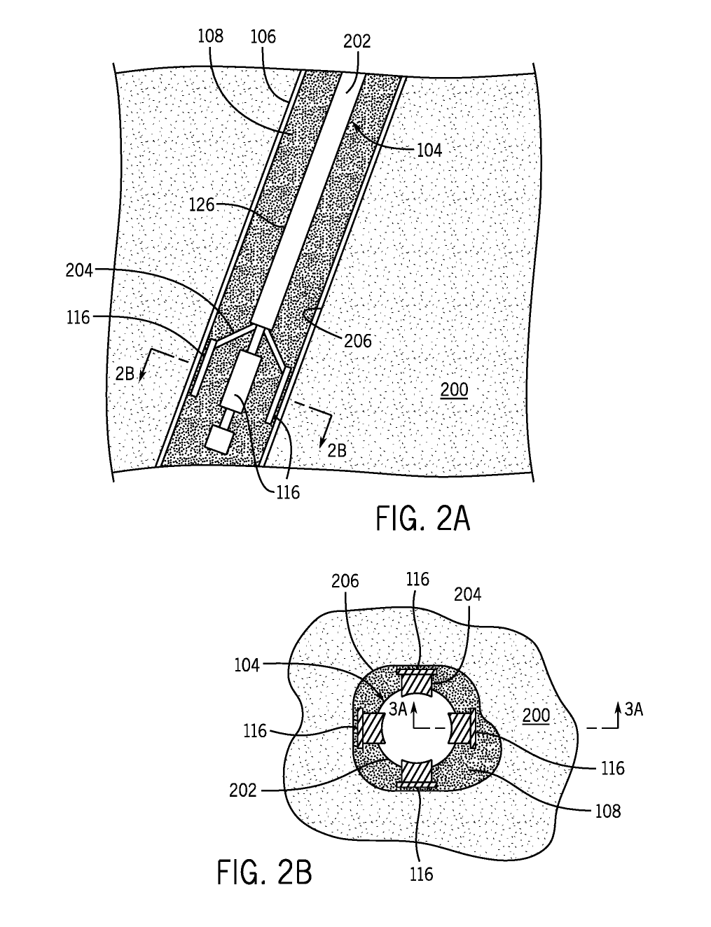

FIG. 2A shows a schematic view of a downhole tool usable as the downhole tool 104 located in the wellbore 106 and within a downhole formation 200. As depicted, the downhole tool 104 is a wireline microresistivity tool containing the conductive pads 116. The conductive pads 116 may be located on the outer surface 126 (as shown in FIG. 1), or located on one or more arms 204 which extend from downhole tool 104 (as shown in FIGS. 2A and 2B). The arms 204 may be configured to place the conductive pads 116 as close to the formation wall 206, or against a mud layer 108 on the formation wall 206, as possible. Thus, the arms 204 may be actuatable, or spring loaded in order to bias the conductive pads 116 against the formation wall 206. FIG. 2B shows a cross-sectional view of the downhole tool 104 in FIG. 2A taken along line 2B-2B. As shown, the downhole tool 104 may include one or more conductive pads 116 located around a tool mandrel 202. Each of the conduictive pads 116 may be configured to measure the downhole parameters, such as the downhole fluid and/or parameters of the formation 200. While the conductive pads 116 of FIG. 2B are depicted as being flat, it will be appreciated that a front face of the sensor face may be rounded to conform to the wellbore wall 206.

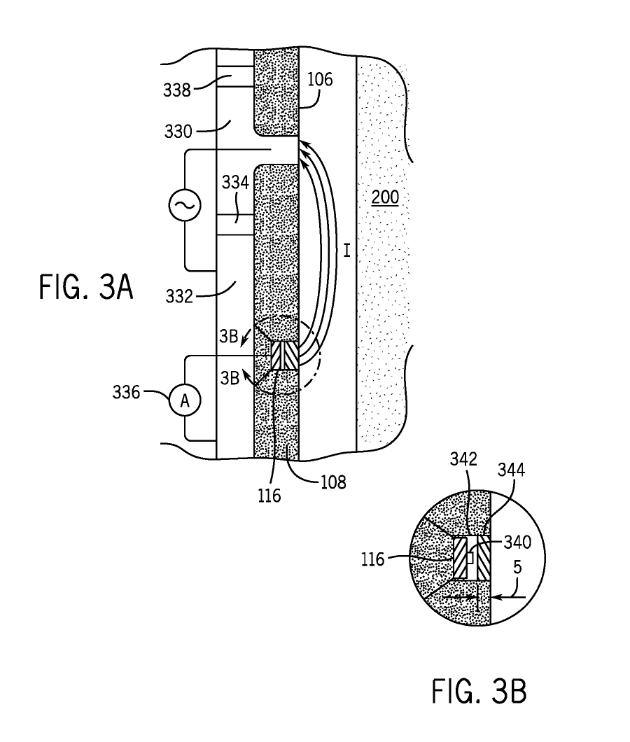

FIGS. 3A-B are partial cross-section views in a borehole showing a part of a downhole tool 104 for current injection according to the invention, used in investigation of geological formations surrounding a borehole. The downhole tool 104 operates at a frequency above in the range of 100 kHz to 10 MHz in some embodiments. In an embodiment, the operating frequency is selected as 1 MHz. The downhole tool 104 can comprise a string of independent modules or tools. The string of tools can include a current injection section 332, a current return section 330 and at least one other section 334.

In the particular example of FIG. 3A, the at least one other section 334 is positioned adjacent to the current return section 330, more precisely below the current return section 330. Additionally, the current return section 330 is positioned adjacent to the current injection section 332, more precisely above the current injection section 332. As shown in FIG. 3A, the conductive CR tool body section 330 comes into direct contact with the formation 200; however, in other embodiments, the conductive CR tool body section 330 may indirectly engage the formation 200.

The current injection section 332 is electrically decoupled from the current return section 330 by means of the at least one other section 334, which is an insulating isolation section. A signal source is connected between the current injection section 332 and the current return section 330. The current injection section 332 is driven at a voltage V=VO(t) with respect to the current return section 330. An additional isolation section 338 electrically decouples the current return section 330 and current injection section 332 from other components in the downhole tool 104. Dual insulation of the mandrel return addresses borehole wave propagation upwards above the voltage gap, as described in U.S. Pat. No. 8,232,803. In an embodiment of the present disclosure, an additional sensor (not shown) may optionally be affixed to the mandrel at a separate segment 50 of the tool string of downhole tool 104 in order to measure borehole wave propagation.

The current injection section 332 comprises a conductive pad assembly (including conductive pad 116 and a standoff spacer, as described below) that is deployed by means of extendable suspension 345 such as arms, blades or the like such that the conductive pad assembly engages the wall of the borehole 106 when extended, but the conductive pad 116 itself does not come into direct contact with the formation. The conductive pad 116 carries a button electrode 340 that measures a survey current injected into the geological formation 200 via the conductive pad 116.

As can be seen by the exploded view of FIG. 3B, the conductive pad 116 supports a button electrode 340 that measures current injected by the conductive pad 116 when the conductive pad assembly is extended to contact the borehole wall 106, with the conductive pad 116 held at a desired standoff S by the standoff spacer 343. The standoff spacer 343, including insulation 342 and wear plate 344, ensures a standoff of at least S when the conductive pad assembly is extended into engagement with the borehole 106. In addition to ensuring against mechanical abuse from the rugosity of the borehole 106, the wear plate 344, with insulation 342, prevents the conductive pad 116 from having direct electrical contact with the formation 200.

The insulator 342 may be any suitable insulating material, such as PEEK (polyetherether-ketone), capable of allowing electrical communication between components. Such electrical communication may be, for example, capacitive coupling between the electrode. In some versions, the PEEK material may be a metal material capable of impeding and/or stopping current flow therethrough at selected frequencies as desired. For example, the PEEK material may prohibit current flow at lower frequencies, but allow current flow at higher frequencies. Although described as PEEK, it should be appreciated that the insulator 342 may be any suitable material for impeding or stopping current including, but not limited to, Sapphire, ceramics, polyimide resin, plastic, and the like.

FIGS. 3A and 3B show the conductive pad 116 having insulation on a borehole-facing side about the button electrode 340. The button electrode 340 may optionally be completely covered with the insulation to help eliminate the need for the individual electrode mounting to seal against borehole fluid entry.

The conductive pad 116 and button electrode 340 may be communicatively linked to the electronics package 120 (FIG. 1). The conductive pad 116 and button electrode 340 may be arranged in a variety of configurations, and should not be limited to the configuration shown in the drawings, primarily depending on the parameters to be measured by the downhole tool 104.

From the voltage and the current electrical properties, or parameters, measured along the current return section 330, various downhole parameters of, for example, the wellbore fluid and/or the formation may be determined. The electrical properties may include, for example, conductivity and permittivity. In certain applications, the downhole tool 104 may measure the amplitude and phase of the voltage and the current I. From the amplitude and phase of the voltage and the current I, the complex impedance may be calculated for the wellbore fluid and/or the formation 200. With the complex impedance known, various electrical properties may be calculated.

From the amplitude of the voltage and the current I, the impedance amplitude may be calculated. With the impedance amplitudes known electrical properties such as absolute conductivity and impedivity may be calculated. In another example, the current return section 330 may be used to measure the phase of the voltage and the current I. From phase of the voltage and the current I, the impedance phase may be calculated. With the impedance phase known, the ratio of conductivity and permittivity may be calculated. Measurements may be taken at several frequencies to optimize response.

Data concerning the measured current may be used to determine fluid or other downhole parameters, such as impedivity, resistivity, impedance, conductivity, complex conductivity, complex permittivity, tangent delta, and combinations thereof, as well as other parameters of the wellbore fluid. The data may be analyzed to determine characteristics of the wellbore fluid, such as the type of fluid (e.g., hydrocarbon, mud, contaminants, etc.) A processor (e.g., located in the logging device 112, the electronics package 120 of FIG. 1) may be used to analyze the data. Optionally, the data may be communicated to the surface unit 114 and/or other location for storage and/or analysis. Such analysis may be performed with other inputs, such as historical or measured data about this or other well sites. Reports and/or other outputs may be generated from the data. The data may be used to make decisions and/or adjust operations at the well site. In some cases, the data may be fed back to the well site for real-time decision making and/or operation.

As illustrated in FIGS. 3A and 3B, standoff spacer343 provides a gap or standoff S between the conductive pad 116 and the wall of the borehole 106 to prevent direct contact therewith when the extendable arms are extended and the conductive pad engages the wall of the borehole 106. As noted, the standoff spacer 343 includes insulator 342 and a wear plate 344 that collectively produce standoff S with the borehole wall 206.

In order to perform phase-sensitive processing accurately, wild fluctuations in the global tool current distribution need to be minimized in the formation and about sensors of the mandrel current return section 330. Strong fluctuations may lead to measurement interpretation problems. For example, if one electrode pad touches the formation directly, then the other electrode pads will immediately read very small currents due to the change in current distribution. Very small current will contain more noise and the current phase measurement may also be perturbed, which can lead to processing and interpretation problems.

Formation bedding and events will influence the global tool current distribution but will not lead to abrupt variation. Changes of the global current distribution will be slowly varying during a given log.

Abrupt, undesirable changes may result from intermittent electrical contact between non-insulated parts of the conductive pad(s) 116 and the formation 200, or between parts of the down-hole tool 104 that are in electrical contact with the conductive pad(s) 116 and the formation 200. Such undesirable contact can be prevented by the insulated protruding wear plates 344 on each conductive pad 116. The wear plates 344 touch the formation 200 while giving the conductive pad 116 some standoff S from the formation 200. The protrusion (created by the insulator 342 and the wear plates 344) should be such that under normal conditions, the rugosity of the borehole wall is not severe enough for the non-insulated metallic parts of the conductive pad 116 to touch the formation 200. At the same time the protrusion is sufficiently small enough such that the conductive pad 116 maintains a small enough standoff distance to the formation for accurately measurements, and deliver high resolution measurements of the wall of the borehole 106.

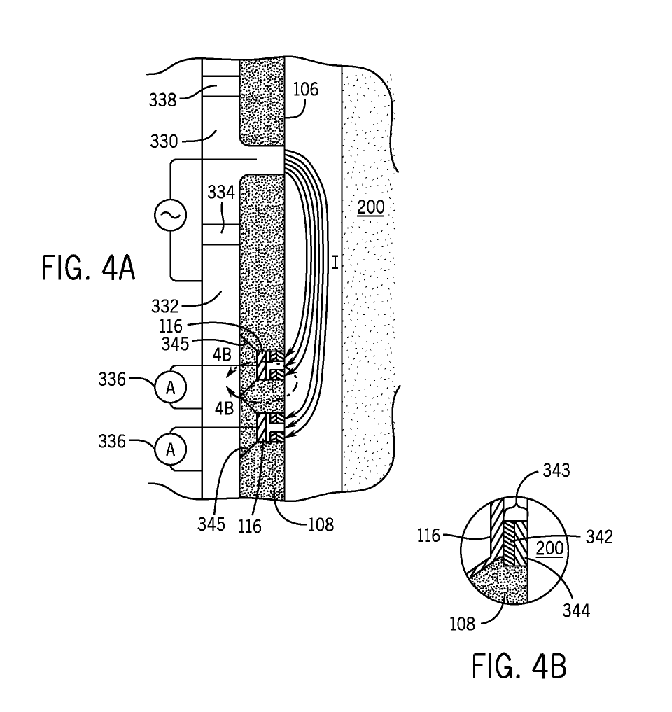

FIGS. 4A and 4B are cross-sectional views of a portion of a downhole tool similar to that of FIGS. 2A and 2B in accordance with another embodiment. FIG. 4A shows the conductive pad 116 as conductive plate having spring loaded or otherwise extendable arms 345 to engage the conductive pad 116 with the wall of the borehole 106. In an embodiment, a button electrode (not explicitly shown) may be embedded in the conductive plate, and sealed therein. The standoff spacer 343, comprising insulation 342 and a wear plate 344, is affixed to the conductive plate, preventing the conductive plate and button electrode from directly contacting the formation 200, even when the conductive pad 116 is fully engaged against the wall. The geometry of the standoff spacer 343 relative to the conductive plate may be tuned for the particular application.

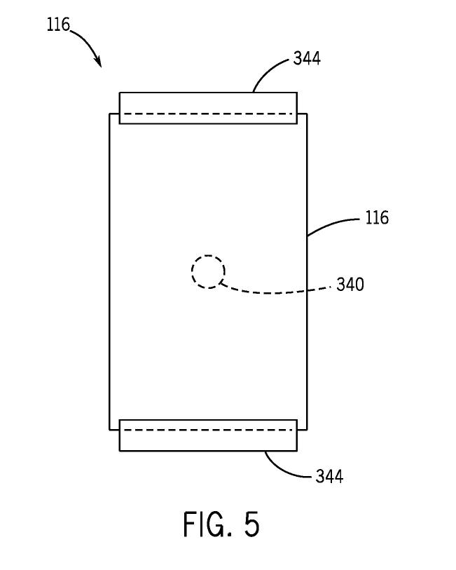

FIG. 5 depicts the conductive pad 116 of an embodiment, in which the wear plates 344 are metal parts affixed to the conductive pad 116. In at least some embodiments, the front, bore-hole-facing side of the conductive pad 116 is provided as a conductive plate for injecting current into the formation, as described herein.) In an example embodiment, the conductive plate is plated by a layer of PEEK of 1 or more mm thickness. In an embodiment, wear plates 344 may have a tungsten carbide coating which in use rubs against the wall of the borehole 106. The wear plates 344 may be affixed to the conductive plate through electrically insulated screws or other standard insulating fixture mechanisms. In a particular embodiment, it has been established a protrusion of around 1.5 mm (due to the insulator 342 and the wear plates 344) suffices to prevent touching of the conductive pad 116 in greater than 95% of a log. In various embodiments, it is possible to tune the protrusion based on pad geometry/size, well smoothness, the particular mud in use, and other factors.

In an embodiment, any additional tool centralizers (not shown but foreseen as likely to be in use for long tool strings) coupled to the section of the mandrel that is electrically connected to the pads 116 can be likewise insulated from the formation.

While the embodiments are described with reference to various implementations and exploitations, it will be understood that these embodiments are illustrative and that the scope of the inventive subject matter is not limited to them. Many variations, modifications, additions and improvements are possible.

Although the preceding description has been described herein with reference to particular means, materials and embodiments, it is not intended to be limited to the particulars disclosed herein; rather, it extends to functionally equivalent structures, methods and uses, such as are within the scope of the appended claims.

Plural instances may be provided for components, operations or structures described herein as a single instance. In general, structures and functionality presented as separate components in the example configurations described above may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus for making resistivity measurements of an underground formation surrounding a borehole, comprising:
a conductive tool body section;
an electrically decoupling insulated tool body section mechanically coupled to the conductive tool body section;
a conductive current return (CR) tool body section mechanically coupled to the electrically decoupling insulated tool body section, the conductive CR tool body section configured for direct contact with the formation;
a pad 116 mounted on the conductive tool body section, wherein the pad comprises:
a conductive plate that injects current into the formation at a frequency in a range above 100 kHz and below 10 MHz;
at least one button electrode that measures current injected into the formation; and
a standoff spacer affixed to the conductive plate, the standoff spacer configured for direct contact with the formation; and
extendable suspension means affixed to the conductive plate, that, when extended, cause direct contact between the standoff spacer and the formation.

2. The apparatus of claim 1, wherein the standoff spacer provides a minimum standoff between the borehole wall and the pad.

3. The apparatus of claim 1, wherein portions of the standoff spacer comprise a tungsten carbide material coating.

4. The apparatus of claim 1, wherein portions of the standoff spacer comprise a PEEK material having a thickness of around 1 mm or more.

5. The apparatus of claim 1, wherein thickness or material of standoff spacer is selected as a function of geometry and size of the pad and smoothness of the borehole.

6. The apparatus of claim 1, wherein the standoff spacer further comprises insulation affixed to the borehole-facing side of the conductive plate and a wear plate affixed to the borehole-facing side of the insulation.

7. The apparatus of claim 1, further comprising a signal source connected between the conductive tool body section and the conductive CR tool body section and operable to generate an injection current.

8. The apparatus of claim 1, wherein the conductive CR tool body section is a mandrel of the downhole tool.

9. The apparatus of claim 1, further comprising signal processing means for generating a resistivity image of the wall of the borehole based on current measured at conductive CR tool body section.

10. The apparatus of claim 6, the insulation having impedance of above 10 Ohms in an oil based mud.

11. The apparatus of claim 1, wherein the extendable suspension means affixing the pad to the conductive tool body section further comprises insulation.

12. The apparatus of claim 1, comprising an additional sensor affixed to tool body section of downhole tool to measure borehole wave propagation.

13. The apparatus of claim 1, wherein the conductive plate injects current into the formation at a frequency above 1 MHz.

14. A method for measuring downhole parameters of an underground formation, the underground formation having a wellbore extending therethrough, the method comprising:
deploying the downhole tool into the wellbore, the downhole tool comprising:
a conductive tool body section;
an electrically decoupling insulated tool body section mechanically coupled to the conductive tool body section;
a conductive current return (CR) tool body section mechanically coupled to the electrically decoupling insulated tool body section, the conductive CR tool body section configured for direct contact with the formation;
a pad mounted on the conductive tool body section, wherein the pad comprises:
a conductive plate that injects current into the formation at a frequency in a range above 100 kHz and below 10 MHz;
at least one button electrode that measures current injected into the formation; and
a standoff spacer affixed to the conductive plate, the standoff spacer configured for direct contact with the formation; and
extendable suspension means affixed to the conductive plate, that, when extended, cause direct contact between the standoff spacer and the formation;
positioning the pad adjacent to the subterranean formation for electrically coupling thereto without direct contact therewith;
passing an electrical signal I having a frequency in a range above 100 kHz and below 10 MHz into the subterranean formation; and
measuring at least one downhole parameter of the formation from the electrical signal I at a location along the conductive CR tool body section electrically decoupled from the pad.

15. The method of claim 14, further comprising deriving an image of the formation surrounding the borehole.

16. The method of claim 14, further comprising applying a phase correction based on a spacing between the current injector electrode and a location of measurement on the conductive current return (CR) tool body section.

17. The method of claim 14, wherein positioning the pad adjacent to the subterranean formation comprises separating the pad by a standoff amount S based on the thickness of the standoff spacer.

18. The method of claim 14, further comprising injecting current into the formation at a frequency above 1 MHz.
